(19) United States
(12) Patent Application Publication
(10) Pub. No.: US 2001/0006696 A1
(43) Pub. Date: Jul. 5, 2001

(54) Instant soakable rice

(76) Inventors: Edmund Lee, Singapore (SG); Ulrich Wissgott, Singapore (SG)

Correspondence Address: PENNIE AND EDMONDS, 1155 AVENUE OF THE AMERICAS, NEW YORK, NY, 100362711

(21) Appl. No.: 09/753,659

(22) Filed: Jan. 4, 2001

(30) Foreign Application Priority Data
Jan. 5, 2000 (SG) 200000077.8

(51) Int. Cl. A23L 1/18

(52) U.S. Cl. 426/625; 426/627; 426/449; 426/461

(57) ABSTRACT

The present invention relates to a method for preparing an instant soakable rice product which comprises dehydrated rice. The instant soakable rice product is rehydrated in use by the addition of hot water over a period of 3-5 minutes. The method of the invention involves a sequence of steps including a first soaking step at ambient temperature, a first steaming step, a second soaking step at an elevated temperature compared to the first soaking step and a second steaming step. The rice is then dried and puffed to form the instant soakable rice product of the invention.

### FIELD OF THE INVENTION

The invention provides a method for preparing an instant soakable rice product which comprises dehydrated rice. The instant soakable rice product can be re-hydrated in a relatively short period of time by the addition of hot water; the rice is then ready for consumption.

### BACKGROUND OF THE INVENTION

In many parts of the world, particularly in Asia, rice is the staple food. In South-East Asia, for example, the average per capita consumption is 100 kg. In many Asian countries rice is served at least twice a day, normally with a protein or vegetable addition. With changing life styles, both in Asia and in other parts of the world where rice is a common food type, there is a need for convenient packaged rice dishes which are easy and quick to prepare, but which have a texture and taste similar to fresh, in-house prepared rice.

A method has not previously been disclosed for obtaining an instant soakable rice product which comprises dehydrated rice. Conventional-processed rice products include frozen rice, retort packaged rice, canned rice and aseptic packaged rice. These conventional-processed rice products can be separated into two main convenience-food types, depending on their method of preparation.

Full-moisture, instant rice products comprise processed whole-grain rice that requires heating for up to 2-3 minutes in a microwave oven or for 10-13 minutes in boiling water before consumption. “Boil-in the bag” products, for example, require that the rice be cooked. Examples of full-moisture, instant rice products include:

Frozen Rice

Frozen rice products consist of cooked and then frozen convenience rice. They are packed in multi-serving and single-portion sachets and are suited to either microwave or conventional reheating. Frozen rice is normally ready to serve in around 3 minutes by microwave heating. Although convenient as a processed rice product, frozen rice requires specialized freezing and refrigeration equipment both for its manufacture and storage.

Retort Packaged Rice

Ready-cooked rice is packaged in high moisture and oxygen barrier plastics or metallic foil prior to retort heat treatment. This processed product requires specialized sterilization equipment. Furthermore, its manufacture and packaging costs are high.

Canned Rice

Ready-cooked, canned rice for both microwave and conventional reheating is usually emptied from the can into a plate or bowl and covered with saran wrap prior to microwave reheating. It is available as white, brown or ethnic style rice.

Aseptically Packaged Rice

Rice is cooked and acidified prior to packaging in a clean environment. A high moisture and oxygen barrier material is used for packaging. This process requires special manufacturing equipment and is associated with high packaging costs.

The second type of product is known as quick cooking rice. This product consists of processed dehydrated whole-grain rice, which also requires cooking for 2-3 minutes, but often up to 10 minutes in a microwave oven, or for 10-13 minutes in boiling water, prior to consumption. Quick cooking rice is faster to cook than raw, unprocessed rice, but nevertheless must first be cooked. This form of instant rice may also be freeze-dried.

There is no instant rice product available, however, which consists of processed dehydrated whole-grain rice that can be ready for consumption within 3-5 minutes merely following the addition of boiling water and which has a texture similar to conventionally cooked rice. A particular advantage of such a product is that no conventional cooking or microwave cooking is required. The addition of boiling water to re-hydrate the rice is sufficient to prepare it for consumption. There still remains a need for improvements in instant rice products and these are provided by the present invention.

### SUMMARY OF THE INVENTION

The present invention provides a method for preparing an instant soakable rice product comprising dehydrated rice which can be re-hydrated and ready to eat within 3-5 minutes by the addition of hot water.

A particular advantage of the instant soakable rice of the present invention is that the texture of the rice is similar to that of traditionally cooked rice; for example, rice cooked in an automatic or traditional Chinese rice cooker, in boiling water over a conventional cooker, or in a microwave oven. When unprocessed rice is cooked by conventional means the moisture content of the cooked rice is within a range of approximately 55-70%, depending on the type of rice. The average cooking time for one serving (approximately 275 g of rice in 320 ml water) is between 16-18 minutes depending on the type of rice.

An additional advantage of the invention is that the instant soakable rice has good hydrostability so that it does not disintegrate in hot water. The method of the present invention minimizes starch loss from the rice.

Furthermore, the process of the present invention is more environmentally friendly than conventional methods of the prior art for producing processed rice products; the water used in the process can be recycled. The process conserves water and energy and is more economical to run. The method of the invention is a continuous process run on a continuous line apparatus.

The present invention, therefore, provides for the first time a method for industrially processing rice to obtain an instant soakable rice product comprising dehydrated rice which has the same quality as rice produced by conventional cooking techniques. The invention involves a continuous process for industrially manufacturing instant rice by fully precooking the whole rice grains under a saturated steam atmosphere, and drying and puffing the rice to impart instant re-hydration properties. The processing conditions allow maximum water absorption that fully cooks the rice, while being environmentally friendly and generating minimum water wastage.

### DETAILED DESCRIPTION OF THE INVENTION

The present invention provides a method for preparing instant rice which comprises a series of sequential steps comprising a first soaking step, a first steaming step, a second soaking step, and a second steaming step to allow about 55% or more water to be absorbed by the rice. The hydration is followed by drying and intense puffing of the rice to result in instant dehydration.

The invention, therefore, provides a method for preparing an instant soakable rice product comprising dehydrated rice, which comprises:

(a) a first soaking step, wherein the rice is soaked in water at ambient temperature to allow water absorption prior to a first steaming step;

(b) a first steaming step, to partially gelatinize the outer surface of the rice grain to allow further absorption of water;

(c) a second soaking step, wherein water is sprayed over the rice to allow the moisture level to reach its maximum within the rice grains, the temperature of the water being higher than the temperature used in the first soaking step, and wherein the water is optionally recycled from this step;

(d) a second steaming step, to complete gelatinization of the starch in said rice;

(e) a pre-drying step; and

(f) a hot-air puffing step,

to obtain a soakable rice product, wherein at least steps (b), (c) and (d) are carried out on a continuous line apparatus, preferably in a single steam tunnel.

The method of the invention achieves a processed rice product having the same texture as conventionally cooked rice, and preferably achieves a moisture content of up to about 75%, preferably between about 55-60% during processing. This value for moisture content coincides with the moisture content of rice during conventional cooking and leads to a home-cooked rice product having the same or similar texture as unprocessed rice. The combination of soaking and steaming steps in the method of the present invention results in the desirable moisture content of the rice.

When rice is cooked in an automatic rice cooker in a conventional manner the rice is boiled until all water is absorbed and the starch is gelatinized. After the water is absorbed, only steam is present within the rice cooker. A final moisture content of between about 55-70% is achieved.

The present invention further provides an instant soakable rice product comprising dehydrated rice obtained by the method of the invention.

In the first soaking step, a polished raw rice kernel, for example, is soaked in water at ambient temperature, preferably at a temperature between about 15-35° C., more preferably at about 28° C., at a 1:1 ratio of rice to water for between about 20 minutes to 3 hours, preferably about one hour. This step allows moisture absorption prior to steaming so that gelatinization of starch can be facilitated. Moreover, at ambient temperature no significant starch loss will result. Soaking at ambient temperature enables a certain level of moisture absorption of the rice grain that otherwise could only be attained with longer steaming times. The moisture content of rice after this stage is usually between about 15-35%. Absorption of moisture for rice follows an asymptotic moisture absorption curve. A preferred time of one hour will suit certain types of rice, for example, Thai rice, to ensure the highest possible level of moisture absorption in the shortest time. The moisture absorption curve, and therefore the soaking time, is a function of the type of rice used in the process of the invention. The first soaking step may be carried out by spraying the rice with water, which can then be recycled.

In the first steaming step, the rice undergoes steaming to partially gelatinize the outer surface of the rice grain. This step is taken to prevent starch loss during the second soaking step which is carried out at a higher temperature compared with the first soaking step. Trials conducted on rice which underwent soaking without this first steaming step indicated that more starch was lost during soaking.

During the first steaming step the rice may be conveyed by a belt through a steaming tunnel where steam is injected into the tunnel at a temperature of between about 98-104° C., preferably about 100° C. The rice is processed in this step for between about 1-15 minutes, preferably about 5 minutes at a steam pressure. The purpose of this step is not to cook the rice, but merely to gelatinize the outer surface of the rice grain to prevent starch leeching during the later soaking stage. Process deviations from the conditions of this step will result in under or over cooked rice. If steaming is carried out for less than 3 minutes, for example, the outer surface of all the rice grains may not be uniformly gelatinized.

During the second soaking step the rice is fed from the first steaming step along a continuous line apparatus and sprayed with water at the desired temperature for the desired amount of time. The water may then be recycled. This enables the process of the present invention to be continuous, for example, using a single steam tunnel, and enables an existing line apparatus to be easily modified to carry out the different operations of steaming and soaking. The amount and manner of water sprayed can be modified depending on the desired texture of the final rice product.

The main function of the second soaking step is to increase the level of moisture within the rice grain up to about 70%, preferably about 55-60%. During this step, the rice is showered with hot water at a temperature of about 85-95° C., preferably about 90° C. for a time of approximately about 3-7 minutes, preferably about 5 minutes. A suitable temperature is just above the gelatinization temperature (55-80° C.) of rice, but lower than the boiling point of water, so that minimal starch loss occurs.

Heating during the second soaking step promotes gelatinization of the starch within the rice grain. Trials conducted on processing rice by steaming alone showed that without the soaking steps a final moisture level of 60% cannot be obtained. Rice steamed for as long as 40 minutes, without the soaking step, had a moisture content of only 35-40%. Without penetration of water during the soaking step, gelatinization of starch within the grain will be less likely. At lower temperatures, longer soaking times are required in order to attain the desired moisture level. At higher temperatures, or by soaking for a longer time, undesirable starch leeching occurs.

A second steaming step is then conducted at a steam temperature of between about 98 and 104° C., preferably about 100° C. The rice is exposed to steam during this second step for approximately about 5-20 minutes, preferably about 10 minutes, in to achieve a final total solids content of between about 37-43%, preferably about 40%, that is, a moisture level of at least about 60%. This second steaming step is important to achieve full gelatinization of the rice grain. In addition, the steam prevents stickiness between the cooked rice grains to ensure a product which is more desirable to the consumer.

The rice according to the present invention is then pre-dried. The rice may be dried, for example, by conventional hot air drying to achieve a final total solids content of between about 86-90%, preferably about 88%, that is, a moisture level of between about 8-15%, preferably about 12%. Drying takes place preferably over about 10-20 minutes, preferably about 15 minutes, with an air velocity of between about 1.0-2.0 m/s, preferably about 1.5 m/s, at a temperature of between about 90-150° C., preferably about 135° C. The rice may be conveyed through a one or multi-stage dryer to achieve the final solids content desired.

If drying is conducted at too high a temperature, too high an air flow or for too long a time, the rice is too dry which could lead to case hardening which affects the puffing of the product.

The moisture level achieved after pre-drying is preferably between about 8-20% since this will determine the puffability of the rice. If the pre-dried rice has less than about 8% moisture, then the rice may appear yellowish from over drying and furthermore, it may not be able to be puffed due to case hardening. If the moisture content is greater than about 20%, the end product may have a higher moisture content than the 4-5% range preferred. This will affect the shelf-life of the product. In the case of an end product with a higher moisture content than the 4-5% range, it is possible to introduce a post-drying step which will help lower the moisture content.

Drying is followed by puffing preferably at a temperature of between about 190-210° C., more preferably at a temperature of about 200° C. for a period of between about 10-20 seconds, preferably about 15 seconds at an air velocity of between about 12-20 m/s, preferably between about 18-20 m/s. The final product has a moisture content of between about 4-5% and has a porous structure. This allows easy and faster re-hydration of the product in use.

The instant soakable rice of the invention may then be used to manufacture a convenience rice dish, for example, with the addition of further ingredients such as dehydrated vegetables or protein, additives, flavorings, colorings, garnish, etc. The product may be packaged as desired for purchase by the consumer.

The instant rice product of the invention may be packaged in a shrink-wrapped polystyrene bowl with a polystyrene lid having small holes at two ends of the container for draining out the excess water added to re-hydrate the rice. The bowl may contain a sachet of dehydrated rice, a sachet of tastemaker, and a sachet of dehydrated garnish.

Re-hydration of the instant, dehydrated soakable rice and dehydrated garnish are carried out by pouring excess hot water at a temperature of greater than 95° C. into the dehydrated products in the polystyrene bowl. Re-hydration time falls within the range of about 3-5 minutes. Excess water may then be drained from the holes by the side of the lid of the bowl. The lid can then be removed by the consumer and the tastemaker added. The rice dish is then mixed well before serving.

The soakable rice product of the invention is preferably whole-grain rice, and more preferably a medium-high amylose content grain of the type which is popular in Asia.

The steps of the method of the present invention may be carried out using conventional processing apparatus, for example, a continuous processing line incorporating conventional apparatus for sequential soaking and steaming of the rice under the suitable processing conditions applicable to each stage. The rice may move through the apparatus continuously on a conveyor belt. Optionally, the instant soakable rice of the invention may be produced as part of an existing rice porridge line extension.

The process of the invention will now be described with reference to the following example, which is not intended to limit the invention.

### EXAMPLE 1

### Suitable Operation of the Method of the Present Invention

| PROCESS | DESCRIPTION/ | PROCESS | |
|---|---|---|---|
| STEP | OPERATION | VARIABLE | TARGET |
| Soaking | Rice kernels soaked with | Batch size | Variable |
| | tap water (1:1 ratio) at | | |
| | room temperature in a | | |
| | soaking bin for 1 hr. | | |
| Steaming | The soaked rice is passed | Feed rate | Variable |
| | through the steaming tun- | Line Speed | Variable |
| | nel for 5 min. to partially | Steam Pressure | 1.5 psi |
| | gelatinize the outer | Steam Temperature | 100° C. |
| | surface of the rice | Steam Time | 5 min. |
| | kernels. | | |
| Soaking | The steamed rice is | Line Speed | Variable |
| | showered with 90° C. | Water Temperature | 90° C. |
| | water for 5 min. by | Soaking Time | 5 min. |
| | spraying the rice with hot | | |
| | water on a conveyor belt. | | |
| Steaming | The fully soaked rice is | Feed rate | Variable |
| | steamed in a steam tun- | Line Speed | Variable |
| | nel for 10 min. to further | Steam Pressure | 1.5 psi |
| | cook the rice kernel and | Steam Temperature | 100° C. |
| | to gelatinized the outer | Steam Time | 10 min. |
| | surface of rice kernels. | | |
| Drying | Rice is conveyed through | Air Velocity | 1.6 m/s |
| | a 2-stage drier for 18 | Temperature | 90-110° C. |
| | min. (1^{st} stage: 10 min, | Time | 18 min. |
| | 2^{nd} stage: 8 min.) | Final Total Solids | ˜88% |
| Puffing | Rice is puffed at 200° C. | Air Velocity | 18-20 m/s |
| | for 15 sec. | Air Temperature | 200° C. |
| | | Time | 15 sec. |

While the invention has been illustratively described herein with reference to specific aspects, features and embodiments, it will be appreciated that the utility and scope of the invention is not thus limited and that the invention may readily embrace other and differing variations, modifications and other embodiments. The invention therefore is intended to be broadly interpreted and construed, as comprehending all such variations, modifications and alternative embodiments, within the spirit and scope of the ensuing claims.

What is claimed is:

1. A method for preparing an instant soakable rice product comprising dehydrated rice, which comprises:
(a) a first soaking step, wherein the rice is soaked in water at ambient temperature to allow water absorption prior to a first steaming step;
(b) a first steaming step, to partially gelatinize the outer surface of the rice grain;
(c) a second soaking step, wherein the rice is sprayed with water at a temperature higher than the temperature of the water in the first soaking step, to increase the moisture level within the rice grains;
(d) a second steaming step, to gelatinize the starch in said rice;
(e) a pre-drying step; and
(f) a hot-air puffing step;
to obtain a soakable rice product, wherein at least steps (b), (c) and (d) are carried out on a continuous line.

2. The method of claim 1 wherein the rice is whole-grain rice.

3. The method of claim 1 wherein in the first soaking step, the rice is steeped in water for about 60 minutes.

4. The method of claim 1 wherein the moisture content of the rice after the first soaking step is between about 15-35%.

5. The method of claim 1 wherein in the first steaming step, the rice is subjected to steam at a temperature of about 100° C. for about 5 minutes.

6. The method of claim 1 wherein the second soaking step is carried out at a temperature of about 90° C.

7. The method of claim 1 wherein the moisture content of the rice after the second soaking step is between about 55-60%.

8. The method of claim 7 wherein the moisture content of the rice is about 60%.

9. The method of claim 1 wherein in the second steaming step, the rice is subjected to steam at a temperature of about 100° C. for about 10 minutes.

10. The method of claim 1 wherein the rice is pre-dried at a temperature of about 135° C. for about 15 minutes.

11. The method of claim 1 wherein the rice is pre-dried in a two-stage drier.

12. The method of claim 1 wherein the moisture level of the rice after the pre-drying step is between 8-20%.

13. The method of claim 1 wherein the puffing temperature is about 200° C.

14. The method of claim 1 wherein the final soakable rice product has a moisture content of between about 4-5%.

15. The method of claim 1 wherein the water used in at least the second soaking step is recycled.

16. A soakable rice product obtained by the method of claim 1.

17. A soakable rice product obtained by the method of claim 1 which can be re-hydrated and ready to eat within 3-5 minutes by the addition of hot water.
